(19) United States
(12) Patent Application Publication
(10) Pub. No.: US 2011/0090135 A1
(43) Pub. Date: Apr. 21, 2011

(54) INTERCHANGEABLE DISPLAY DEVICE FOR A HEAD-MOUNTED DISPLAY SYSTEM

(75) Inventors: Nicole Tricoukes, Seaford, NY (US); Patrick Riechel, Briarwood, NY (US); Tom Roslak, Northport, NY (US); Jorg Schlieffers, Theale Reading (GB)

(73) Assignee: SYMBOL TECHNOLOGIES, INC., Holtsville, NY (US)

(21) Appl. No.: 12/603,366

(22) Filed: Oct. 21, 2009

(51) Int. Cl. G09G 5/00

(52) U.S. Cl. 345/8

(57) ABSTRACT

A head-mounted display apparatus is provided. The display apparatus comprises a rear coupling member having a right end, a left end, and a central portion, a first lateral support member coupled to the right end of the rear coupling member and extending forward from the rear coupling member, a second lateral support member coupled to the left end of the rear coupling member and extending forward from the rear coupling member, and a selectively positionable display assembly adapted to releasably couple to and be supported by either the first lateral support member or the second lateral support member, interchangeably, such that the selectively positionable display assembly extends forward from the first lateral support member when coupled to the first lateral support member and forward from the second lateral support member when coupled to the second lateral support member.

### TECHNICAL FIELD

Embodiments of the subject matter described herein relate generally to devices for mounting objects to the human body. More particularly, embodiments of the subject matter relate to positioning and retaining a head-mounted device.

### BACKGROUND

Portable electronic devices are used in environments where hands-free interaction would be desirable. For example, on construction sites or in warehouses, a user benefits from manipulating objects while still having interaction with an electronic device, such as a mobile computer. Moreover, portable electronic devices typically have compact displays, often measuring only several inches across, or less. Visualizing information on a small display can be limiting both in the total amount of information displayable as well as the increased concentration required by a user to focus on minute graphical images.

Wearable computing devices are sometimes used to allow a user to receive information without the need to carry a separate device. Additionally, such computing devices can include a head-mounted display which presents a screen near the eye of the user. The proximity of the screen to the user's eye, as well as the use of magnifying optics, can result in a screen perceived to be much larger than the actual size of the screen. Because the overall size of the screen appears larger, more information can be displayed at a size easily viewable by the user when a relatively high-resolution screen is used. Such head-mounted displays can be used with non-wearable computing devices as well, with the same benefit.

Head-mounted displays can be cumbersome, heavy, and uncomfortable to wear. Head-mounted displays are typically supported by a bulky, rigid structure passing over the top of the user's head. Such a structure has other drawbacks, including the lack of compatibility with equipment typically used in situations where a head-mounted display is desirable. For example, on a construction site, a user might be required to wear a hard hat or safety glasses. Typical head-mounted displays often inhibit the wearing of such devices.

Moreover, head-mounted displays are often produced either as a one-size-fits-all model with slight fitting arrangements, or custom-made in several sizes from which a user must choose, such as small, medium, and large. Additionally, those head-mounted devices used to support display devices in front of a user's eye benefit from positioning the display device before a user's dominant eye. As users can have either left or right dominant eyes, different models are used for either eye. Consequently, supplying a large number of such head-mounted display devices to a diverse population typically results in either a large number of models or a single model which does not customize well to individuals. Certain types of displays can have clip-on monocular components to permit some interoperability. Typically, such clip-on devices are comparatively fragile, which is undesirable.

### BRIEF SUMMARY

A head-mounted display apparatus is provided. The head-mounted display apparatus comprises a rear coupling member having a right end, a left end, and a central portion, a first lateral support member coupled to the right end of the rear coupling member and extending forward from the rear coupling member, a second lateral support member coupled to the left end of the rear coupling member and extending forward from the rear coupling member, and a selectively positionable display assembly adapted to releasably couple to and be supported by either the first lateral support member or the second lateral support member, interchangeably, such that the selectively positionable display assembly extends forward from the first lateral support member when coupled to the first lateral support member and forward from the second lateral support member when coupled to the second lateral support member.

A head-mounted display system is also provided. The head-mounted display system comprises a first forward extension portion, a second forward extension portion substantially parallel to the first forward extension portion, and a swappable display device adapted to be selectively and releasably coupled to the first forward extension portion and to the second forward extension portion.

A display device for a head-mounted display apparatus is also provided. The head-mounted display apparatus comprises left and right forward extension portions. The display device is adapted to selectively and releasably couple to either the left forward extension portion or to the right forward extension portion, the display device extending forward from the forward extension portion to which it is coupled.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is rear perspective view of a person wearing an embodiment of a head-mounted display assembly;

FIG. 2 is a rear view of the person wearing the embodiment of FIG. 1;

FIG. 3 is a rear perspective view of another embodiment of a head-mounted display assembly;

FIG. 4 is a left side view of the display assembly embodiment of FIG. 3;

FIG. 5 is a rear perspective view of the display assembly embodiment of FIG. 3 worn by a person wearing safety headwear;

FIG. 6 is a top view of another embodiment of a head-mounted display assembly in a first position adjacent a user's head;

FIG. 7 is a top view of the embodiment of FIG. 5 in a second position coupled to the user's head;

FIG. 8 is a rear view of an embodiment of a head-mounted display assembly having an interchangeable display unit in a first position;

FIG. 9 is another rear view of the embodiment of FIG. 8 having the interchangeable display unit in a second position;

FIG. 10 is a front view of the embodiment of FIG. 8 having the interchangeable display unit in the first position;

FIG. 11 is another front view of the embodiment of FIG. 10 having the interchangeable display unit in the second position; and

FIG. 12 is a detailed view of an embodiment of the interchangeable display unit and coupling site;

FIG. 13 is a detailed view of an alternative embodiment of the interchangeable display unit and coupling site; and

FIG. 14 is a detail view of a joint assembly having positioning assistance markers.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

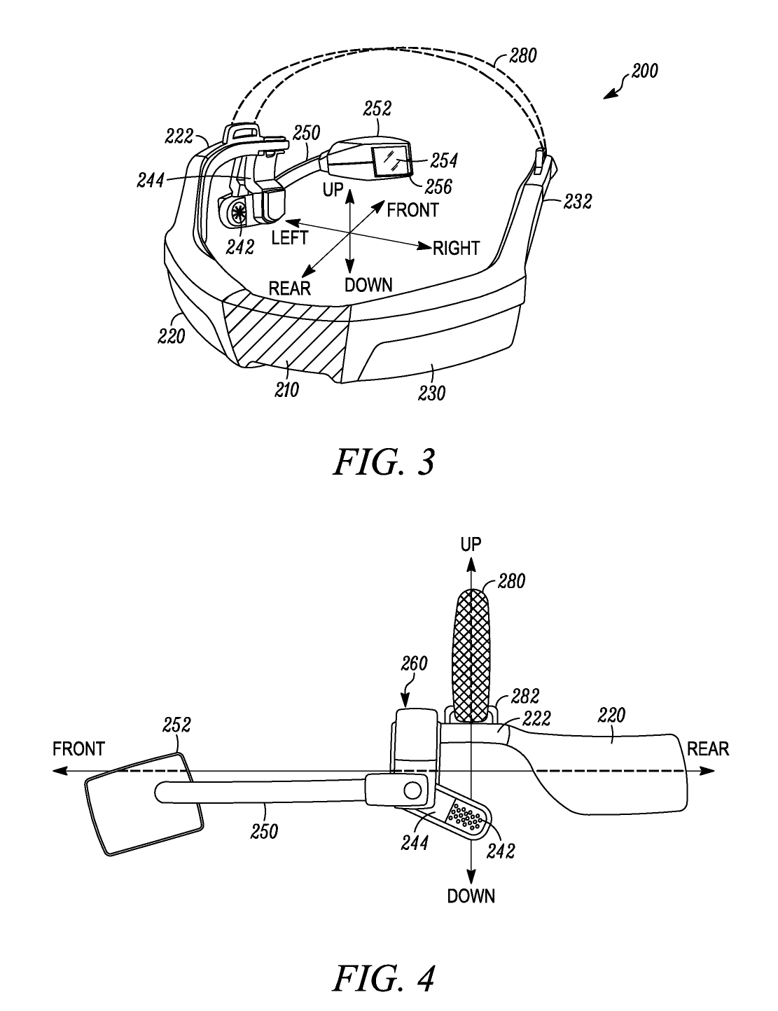

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the schematic shown in FIGS. 3 and 4, for example, depict one exemplary arrangement of elements, additional intervening elements, devices, features, or components may be present in an embodiment of the depicted subject matter.

“Adjust”—Some elements, components, and/or features are described as being adjustable or adjusted. As used herein, unless expressly stated otherwise, “adjust” means to position, modify, alter, or dispose an element or component or portion thereof as suitable to the circumstance and embodiment. In certain cases, the element or component, or portion thereof, can remain in an unchanged position, state, and/or condition as a result of adjustment, if appropriate or desirable for the embodiment under the circumstances. In some cases, the element or component can be altered, changed, or modified to a new position, state, and/or condition as a result of adjustment, if appropriate or desired.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. These and other similar terms, such as “front”, “back”, “rear”, “side”, and so on, describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

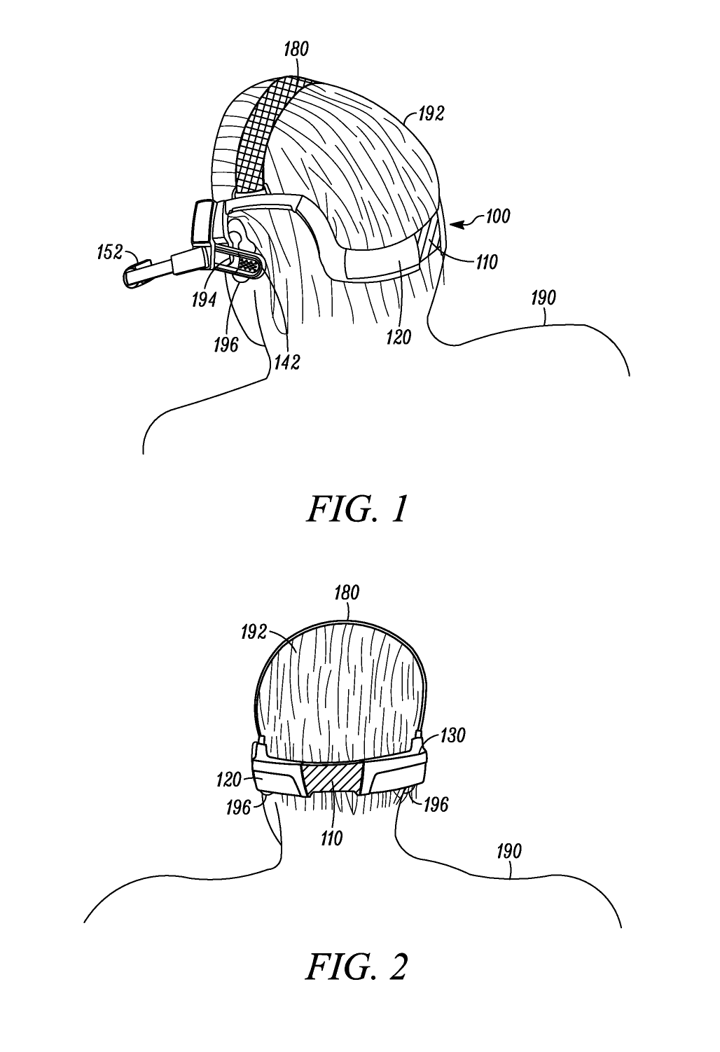

FIG. 1 illustrates an embodiment of a head-mounted display assembly 100 worn by a user 190. The display assembly 100 preferably couples to the head 192 of the user 190, appropriately positioning various presentation elements for convenient reception by the user 190. For example, a display device 152 can be positioned for viewing in front of an eye 194 of the user 190. Similarly, an audio device 142 can be positioned near an ear 196 to provide audible signals to the user 190. The display assembly 100 can be held to the head 192 with a pivoting member 110 which brings first and second side portions 120, 130 towards the head 192, thereby clamping the display assembly 100 to the user 190. A stabilization or support member 180, such as a strap, can also be used to provide additional contact or to inhibit pressure from the extension portions 222, 232 on the ears 196.

With additional reference to FIG. 2, a rear view of the display assembly 100 shows the first and second side portions 120, 130, which are coupled together by the pivoting member 110. The display assembly 100 can have an additional support member 180 across the top of the head 192 during use. The pivoting member 110 preferably pivots around a central portion, such as a hinge, to bring the first and second side portions 120, 130 into tighter contact with the head 192.

FIGS. 3 and 4 illustrate another embodiment of a head-mounted display assembly 200. Unless otherwise indicated, components are substantially similar to those described above, except that the numerical designator has been incremented by 100. Reference is made throughout to such directions as right, left, front or forward, rear or backward, up or upward, and down or downward in context of the directions illustrated, such as the directions shown in FIGS. 3 and 4. As stated above, such reference is made to components within a consistent but arbitrary frame of reference for descriptive purposes and is not intended to limit features of those components to functioning solely in such orientations.

The display assembly 200 can include the first and second side portions 220, 230, the pivoting member 210, extension portions, such as the first extension portion 222, a joint assembly 260 coupled to the first extension portion 222, an audio device 242, a display device 252, as well as other components. The stabilization or support member 280 can be coupled to the display assembly 200 at one or more attachment points 282. The audio device 242 can be coupled to the joint assembly 260 by an audio arm 244. Similarly, a display extension member can couple the display device 252 to the joint assembly 260.

The first and second side portion 220, 230 are components of the display assembly 200 adapted to contact and couple to an object between them. The side portions 220, 230 can have various shapes and sizes, including the substantially quadrilateral prism shapes shown. The side portions 220, 230 can include numerous types of components useful for the display assembly 200, including ports, processing devices such as mobile computing devices, lighting devices or other status indicators, a global positioning system device, wireless antennas, which can be coupled to the processing devices, for use in communicating with remote networks, as well as cellular antennas for use in telephonic operations. The side portions 220, 230 can also include battery devices, memory devices, imaging devices, such as cameras or other sensors, whether digital or analog, as well as tactile components, such as pads, straps, and various contact surfaces to adjust the contact interface of the side portions 220, 230.

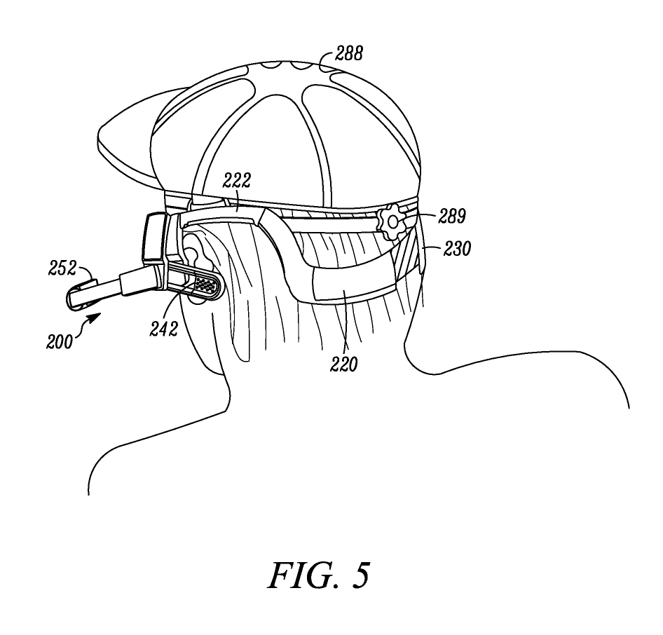

The side portions 220, 230, can alternatively be referred to as gripping, contact, or clamping members or portions, as they provide the primary contact surface for the display assembly 200. The side portions 220, 230 can couple to the rear of a user's head, as shown in FIGS. 1 and 2, as well as FIGS. 5-7. In certain embodiments, the side portions 220, 230 can be formed to contact the lower half of the user's head. In some embodiments, the side portions 220, 230 can have a curved inner surface, where the curvature is adapted to provide comfort and/or stability to the user when wearing the display assembly 200. The side portions 220, 230 can have detachable components, such as a removable inner liner or strap, which can be replaced as desired. Whether through the use of a liner or direct texturing, the inner surface of the side portions 220, 230 can have features aiding in retaining the position of the display assembly 200, such as sticky, tacky, or relatively high frictional surfaces.

The side portions 220, 230 can be shaped to avoid interaction with other equipment the user may wear. For example, the side portions 220, 230 can be positioned downward relative to the extension portions 222, 232 to extend around the back of the user's head that the user can wear a hard hat, or other safety headwear. FIG. 5 illustrates an exemplary embodiment of the display assembly 200 worn by a user with a hard hat 288. Certain headwear can include an adjustment device 289 positioned at the rear of the head as well. The side portions 220, 230 and pivoting member 210 can be shaped or positioned to reside low enough on the head to avoid contacting the adjustment device 289. Thus, the display assembly 200 can extend around the rear of the user's head below the bottom of a rear portion of the hard hat, safety hat, or other headwear. Such shape modifications can include recesses, notches, or curvature to avoid overlying the surface of the user's head where the adjustment device resides.

The pivoting member 210 can couple the side portions 220, 230 to each other, as well as provide the clamping or squeezing force used to maintain the position of the side portions 220, 230. In some embodiments, the pivoting member 210 can also bias the side portions 220, 230 inward toward each other. The pivoting member 210 can be any device or assembly which can provide a pivot point between the side portions 220, 230. Thus, the pivoting member 210 can be a hinge or hinge assembly, a ball-and-socket assembly, a flexible solid member, or any other pivoting device or assembly. Accordingly, the pivoting member 210 can have one or more springs, joints, flexible members, or other components appropriate to perform the described functions.

The pivoting member 210 can have sufficient stiffness to remain in a position once manipulated to that position. Thus, a user can manipulate the display assembly 200 to couple to the rear of her head by clamping the side portions 220, 230 thereto. The pivoting member 210 can have sufficient stiffness to remain clamped in a particular position until manipulated to a new position. The clamping force can be sufficient to support the weight of the display assembly 200, allowing it to couple to objects, such as a user's head, from the side. The clamping force provided by the pivoting member 210 can vary depending on the embodiment. For example, some pivoting members can provide only a single pound or less of clamping force, while others can provide more, such as eight, ten, twelve pounds of clamping force, or more. In certain embodiments, the amount of stiffness and/or biasing force the pivoting member 210 provides can be adjusted, such as by twisting a knob or any other desired technique.

The pivoting member 210 can be enclosed or surrounded by material, such as a coating or housing, so long as it is capable of the functions described herein. The pivoting member 210 can be positioned at the rearmost point of the display assembly 200, either in the middle as viewed from left to right, as shown, or offset to either side. In those embodiments with an offset pivoting member 210, the first and second side portions 220, 230 can be of different sizes to accommodate the position of the pivoting member 210.

Each side portion 220, 230 can have a respective first and second extension portion 222, 232. The first and second extension portions 222, 232 can project forward from the respective side portion 220, 230. The first and second extension portions 222, 232 can extend forward at a level higher, or further up, than the level of the first and second side portions 220, 230. The extension portions 222, 232 can have features which aid comfort during wearing, such as a contoured inner surface, and/or an liner, such as a rubber strip along surfaces contacting the user's head. Such features can be removable and/or replaceable.

The first and second extension portions 222, 232 can couple to additional components, as desired for the embodiments. The first extension portion 222 is exemplary of components of a display assembly which can be coupled to a side portion by an extension portion. As can be seen in the side view of FIG. 4, the first extension portion 222 can be coupled to a joint assembly 260. Preferably, the first and second extension portions 222, 232 do not inhibit similar mounting of eyewear, safety eyewear, such as safety glasses or face shields, and so on, near the ears of the user. Accordingly, the first and second extension portions 222, 232 need not contact or rest against the ears of the user. They can instead contact the user's head above the ear, permitting other devices, including eyewear and safety eyewear to support themselves on the user's ears without interference from the display assembly 200. The support member 280 can assist in positioning the first and second extension portions 222, 232 in a location to avoid contacting the ears and/or eyewear of the user. Accordingly, the support member 280 can be adjustable as desired by the user, such as by shortening or lengthening it.

The joint assembly 260 can include various rotating and flexible members, such as hinges, ball-and-socket joints, elbow and shoulder joint assemblies, and so on, which couple to other components. For example, the audio device 242 is coupled to the joint assembly 260 by the audio arm 244. The audio arm 244 can be rotatable around a pivot point coupled to the joint assembly 260 in certain embodiments. In some embodiments, the audio arm 244 can be a flexible member, with any desired stiffness, to permit additional adjustability. Thus, the audio device 242 can be positioned any desired location within the adjustment range of the audio arm 244.

Similarly, the display extension member 250 can be coupled to the joint assembly 260 using one or more hinge or joint devices. The display extension member 250 can be free to rotate, pivot, or otherwise have its position adjusted to any desired location, resulting in adjustable placement of the display device 252 in a viewable location and orientation. In certain embodiments, the display device 252 can also have positioning devices, such as joints, pivots, and hinges, which permit it to be positioned independently to the positioning of the display extension member 250 from the joint assembly 260.

The audio device 242 can be any device or system capable or producing audio signals. For example, the audio device 242 can be a speaker. In certain embodiments, the audio device 242 can be coupled to at least one of the side portions 220, 230.

Similarly, the display device 252 can be any optical display or device capable of producing a visual signal, such as a light-emitting source, including light-emitting diodes, as well as complex display devices, including miniature graphical screens, such as liquid crystal display (LCD) screens and organic light-emitting diode (OLED) screens. In the embodiment illustrated in FIG. 3, a screen 254 is shown facing inward. In other embodiments, simple graphical devices, such as lights, can also be used. Although illustrated as a solid device, the display device 252 can, in certain embodiments, have one or more transparent elements, including a transparent screen 254, onto which visual signals can be produced overlying background images the user observes through the transparent screen 254. Certain embodiments of the display device 252 can have optical features, such as magnifying lenses, which adjust the image from the screen 254 as seen by the user, or safety features, such as a rim or flange. In some embodiments, the display device 252 can receive as well as present information, such as a retinal scanning device.

It should be understood that the display assembly 200 is not limited to merely supporting and positioning a display device, such as the display device 252. Rather, any appropriate component, such as a camera, solely audio device, such as a microphone or speaker, or any other interaction device can be mounted using the features of the display assembly 200. Thus, the display assembly 200 can be adapted to support one, or a combination, or such devices while embodying other features, such as the pivoting member 210 and first and second side portions 220, 230.

The display extension member 250 can be a single, solid device, such as a flexible arm, or it can be multiple segments jointedly or hingedly coupled together and to the joint assembly 260. Thus, the display extension member 250 can be bent or angled by the user to assist in desirable and/or comfortable positioning of the display device 252. In addition to the display device 252, one or more microphones 256 or other audible sensor can be positioned at an end of the display extension member 250, as shown. The display extension member 250 can project forward from the joint assembly 260, as well as upwards, as well as being adjustable to any range of motion in between. In certain embodiments, the microphone 256 can be positioned in or coupled to the display extension member 250 in places other than near the display device 252. Moreover, the microphone 256 can be positioned in or near the audio device 242, such as on the audio arm 244, as well as in or on the extension portions 222, 232. In some embodiments, the microphone 256 can be positioned on a portion of the display device 252. Additionally, multiple microphones can be used in certain embodiments, each positioned differently, if desired.

The support member 280 can be a strap, as well as any device or member which extends between the first and second side portions 220, 230. The support member 280 can extend upward in an arch, as shown, or can have a different shape. The support member 280 can be adjusted to adjust the position of the display assembly 200, in cooperation with manipulation of the pivoting member 210. In certain embodiments, the support member 280 can be omitted entirely. The support member 280 can be a flexible and/or extendable item, such as an elastic or nylon strap, or an adjustable length of inelastic strap which can be adjusted to fit the head size of the user. In certain embodiments, the support member 280 can comprise multiple discrete segments. The support member 280 can be multiple support members coupled to the side portions 220, 230 pivoting member 210, and/or extension portions 222, 232, as well, resulting in the support members extending in other directions than the right-to-left direction illustrated. The support member 280, whether one or more members, can be thin and flexible enough to reside underneath a hard hat or other safety headwear.

Where necessary, the display assembly 200 can include multiple wires or other connecting mechanisms for interconnecting components. For example, in those embodiments where the display assembly 200 includes a mobile computing device comprising or coupled to a side portion, the mobile computing device can operate the audio device 242 to produce sounds. The side portion 220 can be coupled to the audio device 242 using a wire, if desired. Similarly, for example, the display device 252 can be connected to the first side portion 220 by a wire extending backward from the audio device 242 along the display extension member 250, through the joint assembly 260, and along the first extension portion 222. In other embodiments, including those without computing devices, wires can be used to connect the display device 252 to one or more ports in a side portion 220, 230, permitting the display device 252 to present information from an external processing device. In some embodiments, such an external processing device can couple to the components of the display assembly 200, such as the display device 252, audio device 242, and so on. Features described above can be performed by, or coupled to, either side portion 220, 230, as desired for the embodiment

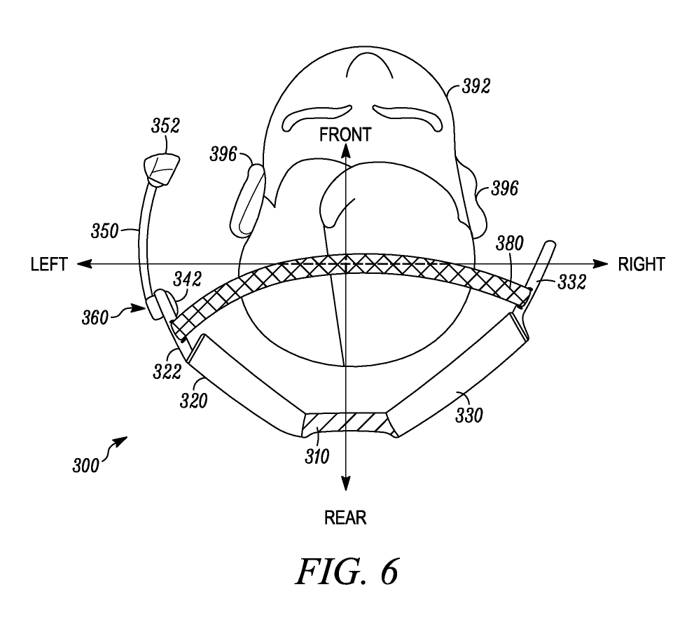

FIG. 6 illustrates another embodiment of a display assembly 300. The display assembly 300 is shown in a first position near a user's head 392. Unless otherwise mentioned, the numerical indicators used refer to those components described above with respect to FIGS. 1 and 2, and FIGS. 3 and 4, except that the number of the designator has been incremented by 200 and 100, respectively.

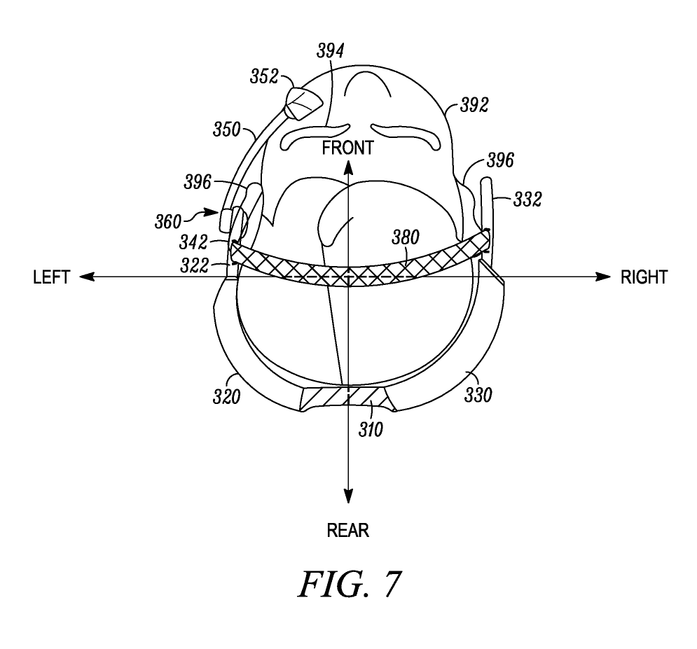

The display assembly 300 is shown in a position from which it can be coupled to the user's head 392. FIG. 7 illustrates the display assembly 300 coupled to the user's head 392. The user can position the display assembly 300 behind his head 392, with the display device 352 projected forward and the support member 280 positioned at a desired place across the head 392. The gripping or side portions 320, 330 can then be pressed inward 392, and rotated about the pivoting member 310 until the display device 352 is positioned as desired. The display assembly 300 can retain its position against the user's head by the inward squeezing or clamping force from the pivoting member 310 as well as additional support from the support member 380. Additionally, the first and second extension portions 322, 332 can extend forward above the user's ear, optionally resting thereon. The extension portions 322, 332 can extend substantially parallel along the side of the user's head 392. They need not be exactly parallel in any frame of reference, but, as shown, can extend in a similar direction on either side of the head 392. The user 390 can then adjust the audio arm 344 to position the audio device 342 to a desired location adjacent or against the ear 396. Similarly, the joint assembly 360 and display extension member 350 can be adjusted to position the display device 352 at a desired position for observation by the user's eye 394.

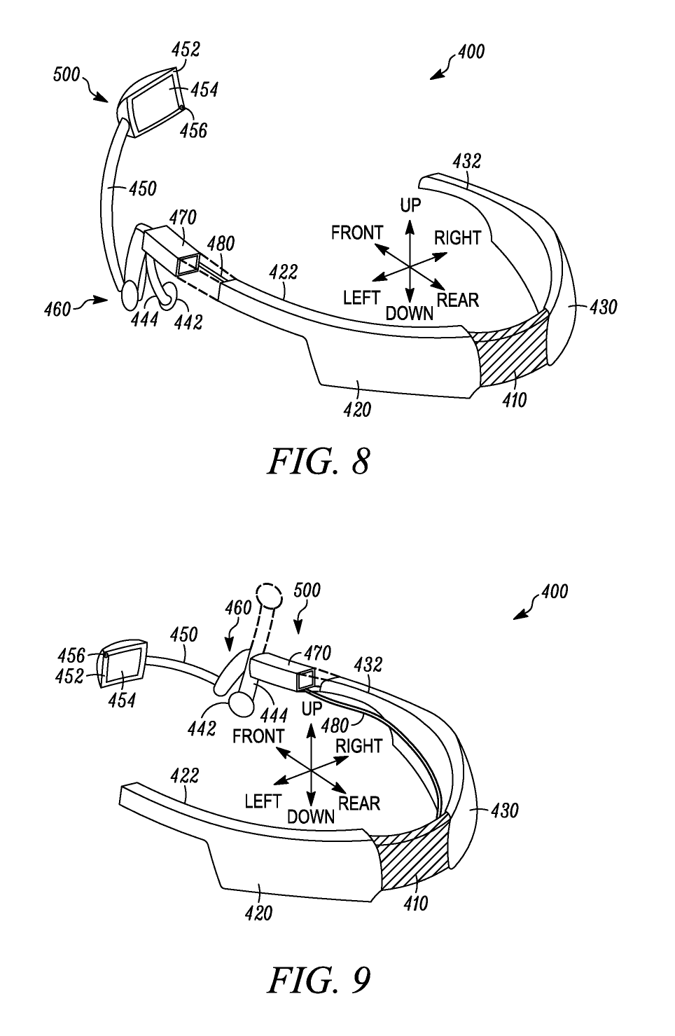

FIG. 8 illustrates another embodiment of a display assembly 400. The display assembly 400 includes an interchangeable display unit 500. The display unit 500 is shown in a first position near the first extension portion 422. With reference to FIG. 9, the display assembly 400 is shown with the display unit 500 in a second position near the second extension portion 432. Some components with similar names and features to those described above are marked with a numerical designator which has been incremented by 300 and 200, from those of FIGS. 1 and 2, and FIGS. 3 and 4, respectively. Some components and numerical indicators differ, however, and are explicitly described below. For clarity, some components are omitted, such as the support member 280. Features from the above-described components and those described with respect to FIGS. 8-12 can be optionally present or omitted to form combinations in any single embodiment, as desired.

FIGS. 8 and 9 illustrate a display assembly 400 having an interchangeable display unit 500. To facilitate use of the display assembly 400 by users with different dominant eyes, the display unit 500 can be selectively, releasably coupled to either extension portion 422, 432. The display device 452 can be positionable using the joint assembly 460 to adjust the orientation of the display device 452 on either side of the display assembly 400.

The display unit 500 can have a coupling portion 470 adapted to couple to either extension portion 422, 432. In the illustrated embodiment, the coupling portion 470 is shown as a sleeve or sheath which receives the forward end of the desired extension portion. For example, in FIG. 8, the coupling portion 470 is shown positioned to couple to the first extension portion 422. The coupling portion 470 can be coupled to the first extension portion 422 by any desired mechanism or technique, such as an interference fit, a latching or locking device, a clasp or locking device, and so on. The coupling portion 470 can retain the display unit 500 to the first extension portion 422 to allow the user to position the display device 452. The display unit 500 can be coupled to the first side portion 420 by a wire 480 extending from the wire port 488 to the coupling portion 470. When coupled together, the display unit and first extension portion 422 can appear as illustrated previously in FIGS. 1-7. The wire 480 can permit interoperation between components of the display unit 500 and other portions of the display assembly 400. For example, a processing component can operate the screen 454 using signals transmitted through the wire 480. The wire 480 can also physically couple the display unit 500 to the display assembly 400 as a tether.

The display unit 500 can be uncoupled from the first extension portion 422 and instead coupled to the second extension portion 422. Each extension portion 422, 432 can function as a lateral support member which supports the display unit 500. The coupling portion 470 can have features designed to couple to both extension portions 422 regardless of orientation. For example, where a latching technique is used, and a protrusion is present on the coupling portion 470, the protrusion can be present on all sides or surfaces of the coupling portion 470, permitting it to be coupled in any orientation. As shown in the illustrated embodiment, the coupling portion 470 can be rotated at least 180 degrees when changing the display unit 500 from one side to the other. The joint assembly 460 can permit flexure or additional rotation, either in range of degrees of rotation, or as rotation in different directions, such as out-of-plane with the audio arm 444. Similar feature adjustments can be made for different coupling techniques.

Thus, the coupling portion 470 can couple to the second extension portion 432. The joint assembly 460 can be adjusted to position the display device 452 as desired, which can include adjustment of the display extension member 450. The audio arm 444 can be adjusted to position the audio device 442 in a desired orientation for use in the new location. Accordingly, the joint assembly 460 and/or audio arm 444 can have coupling and adjustment devices which permit rotation through at least 180°, and some can have greater ranges, as desired.

For example, when the display unit 500 is moved from the first extension portion 422 to the second extension portion 432, the audio arm 444 can initially project upward, as shown by the dashed lines. The audio arm 444 preferably can adjust the position of the audio device 442 to a downward position, as shown, for comfortable use adjacent an ear of a user. The joint assembly 460 can be similarly adjusted, if desired. Certain features, such as the microphone 456 can retain a different orientation, as illustrated.

The wire 480 can maintain a coupling between the display unit 500 to the first side portion 420. The wire 480 can couple to the display device 452 to permit a remote processing device to operate it. For example, a mobile computing device embodied at least in part in one of the side portions 420, 430 can operate the screen 254 to produce visual images. Accordingly, the wire 480 can extend into the housing of the display device 452, or can extend into the display extension member 450 and travel within it to reach the display device 452. In certain embodiments, the display unit 500 can comprise a wireless antenna in addition to or instead of the wire 480.

The display device 452 can include a sensor, such as an accelerometer. In certain embodiments, the wire 480 can provide information from the accelerometer to one or more processing devices. Additionally, in certain embodiments, the display device 452 can be configured to produce graphical images in a plurality of different orientations through any of a variety of techniques. For example, an electronic presentation of a graphical image can be displayed in different orientations by operating the display device 452 to produce an inverted image, if desired. Alternatively, the display device 452 can couple to one or more sensors, such as an accelerometer. In such an embodiment, the display device 452 can be configured to produce an image in a desired direction, such as oriented with a vertically upward direction opposite to the direction of gravity as determined by input from the accelerometer. In still other orientations, the display device 452 can comprise one or more components which physically reposition themselves to produce a graphical image in different orientations. In certain embodiments, the orientation of images displayed on the display device 452 can be commanded by the user by providing input to a processing device, such as by voice command, as detected by the microphone 456,

Thus, regardless of whether determination of image orientation occurs at a processing device controlling the display device 452 or in one or more components of the display device 452, different orientations of images can be produced. Consequently, the orientation of image produced on the display device 452 can be adjusted to appear in a desired direction for the user. Accordingly, then the user adjusts the position of the display unit 500 to an inverted position, graphical images can be displayed on the display device 452 in a manner oriented to the user. The display device 452 can be rotationally coupled to the display extension member 450, allowing a user to rotate it to a desired viewing position. In certain embodiments, the display device 452 can comprise one or more audio sensors and/or audio devices, such as speakers. Other command input techniques, such as manipulation of a button or switch, can also be used.

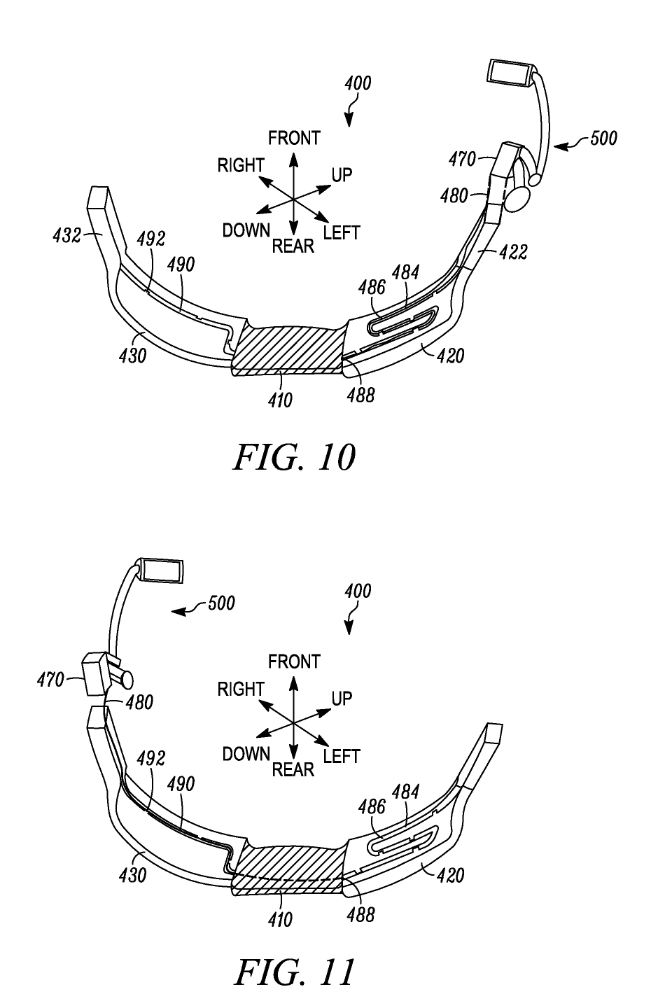

As shown in FIGS. 10 and 11, the side portions 420, 430 can each have one or more channels or grooves to retain the wire 480. With initial reference to FIG. 10, the display unit 500 is shown adjacent the first extension portion 422. The wire 480 extends along a first groove 484 in the inner surface of the first side portion 420. The first groove 484 can have any width and/or depth desired to accommodate the wire 480. The first groove 484 can have a serpentine path, as shown. The wire 480 can extend in the first groove 484 to the wire port 488. The wire port 488 can be positioned anywhere desired on the first side portion 420 appropriate for the components embodied therein. The wire port can have a seal or sealing member to inhibit contaminants and/or moisture from entering the first side portion 420. The first groove 484 can have an altered shape to pass the wire 480 from the wire port 488 to the first extension portion 422, as necessary. In certain embodiments, the first groove 484 can extend into the first extension portion 422.

The first groove 484 can have one or more flanges 486, protrusions, or extensions which retain the wire 480 within the first groove 480. The flanges 486 can be formed so as to permit the wire 480 to be inserted or removed from the first groove 484, while still retaining it during incidental contact. In the embodiment depicted in FIG. 10, the grooves are exposed and accessible at the inner surfaces of the side portions 420, 430. This allows user manipulation of the wire 480 as desired. In certain embodiments, a liner or cover can overlay the surfaces containing the grooves 484, 490.

When the display unit 500 is coupled to the second extension portion 432, as shown in FIG. 11, the wire 480 can be removed from the first groove 484 and positioned in a second groove 490 present on the surface of the second side portion 430. The second groove 490 can have similar characteristics to the first groove 484, accommodating the wire 480. Accordingly, the second groove 490 can have one or more flanges 492 which extend outward to retain the wire 480 within the second groove 490. In certain embodiments, such as those shown in FIGS. 8-11, the wire 480 can be a permanent feature of the display assembly 400, including its coupling points to the display unit 500 and at the wire port 488. In other embodiments, the wire 480 can be selectively detachable, such as to permit display units to be exchanged or replaced between different display assemblies 400.

The second groove 490 can have a less serpentine shape. Thus, the wire 480 will follow a shorter path from the wire port 488 to the second extension portion 432 (relative to the path the wire 480 occupies in the first groove 484). The wire 480 extends a greater distance to the display unit 500 when it is coupled to the second extension portion 432 than when it is coupled to the first extension portion 422. The wire 480 can therefore have a length sufficiently long to extend through the second groove 490 to reach the display unit 500 when it is coupled to the second extension portion 432. When the display unit 500 is exchanged to be coupled to the first extension portion 422, however, the wire length 480 is greater than that needed to reach the display unit 500. The first groove 484 can be correspondingly longer to retain the entire length of the wire 480, thereby avoiding slackness in the wire 480, or extra loops or curls outside the first groove 484. Thus, even though the length of the wire 480 from the wire port 488 to the coupling portion 470 is fixed, the lengths of the grooves 484, 490 can be selected such that the wire 480 is neatly and securely held in place regardless of whether the display unit 500 is attached to the left side or the right side.

The wire 480 can extend across the pivoting member 410 to reach the second groove 490. In some embodiments of the pivoting member 410, it too can have a groove. In certain embodiments, the pivoting member 410 can have a detachable or removable inner surface. In such embodiments, the wire 480 can be positioned underneath the inner surface, such as under a rubber lining. In some embodiments, the inner liner or removable surface can extend across the inner surfaces of the first and second side portions 420, 430 as well as the pivoting member 410. In some embodiments, the inner surface or liner can have multiple discrete segments, or one continuous shape.

It should be understood that while the display assembly 400 has been shown in a particular configuration with the wire port 488 positioned on the first side portion 420 and a longer first groove 484 than second groove 490, it is not limited to such an embodiment. Thus, in other embodiments, the groove lengths can vary according to the positioning of the wire port 488, with the second groove 490 longer than the first groove 484 in certain embodiments.

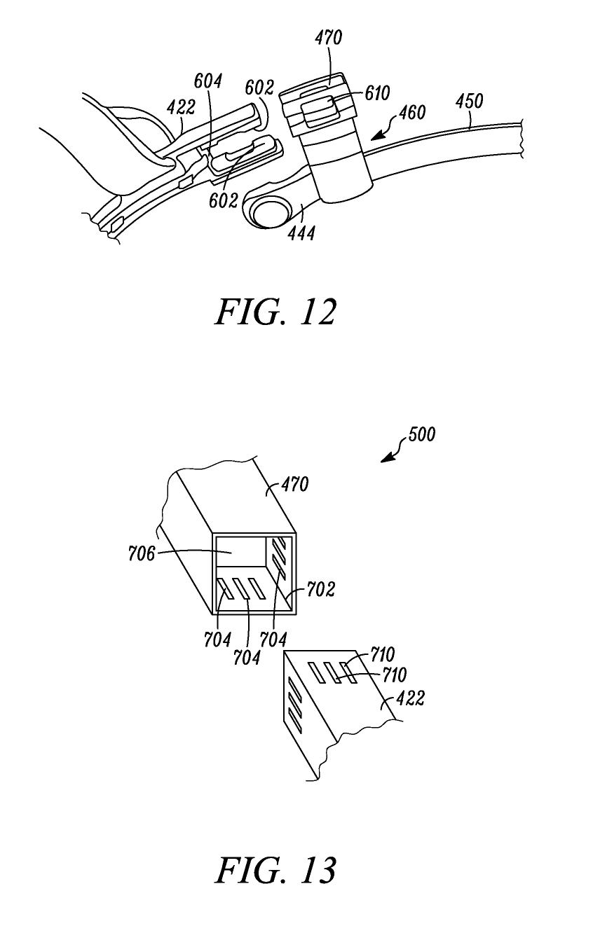

FIG. 12 illustrates a detailed view of the coupling portion 470 and first extension portion 422. Although the first extension portion 422 is shown, the second extension portion 432 can have similar features for receiving and coupling to the coupling portion 470.

The first extension portion 422 can have a receptor 600 adapted to receive and detachably retain part of the coupling portion 470. The receptor 600 can have inward-extending protrusions 602. The coupling portion 470 can have a grooved or slotted insert portion 610 adapted to fit into a socket 604 of the receptor 600. Thus, the coupling portion 470 can be inserted into the receptor 600 in the direction of the arrow. The protrusions 602 can retain the coupling portion 470, coupling it to the first extension portion 422. The coupling portion 470 can be inserted and retained, and subsequently removed, as desired by the user. In certain embodiments, a blank or placeholding insert can be used in a receptor not currently coupled to the display unit 500.

FIG. 13 illustrates a detailed portion of an alternative embodiment of the display assembly 400. The coupling portion 470 can have an interior cavity 706 sized and shaped to receive the first extension portion 422. Although the first extension portion 422 is used for descriptive purposes, a similar configuration can be present on the second extension portion 432 for interchangeable use by the display unit 500.

The surfaces 702 of the interior of the cavity 706 can have one or more electrical connection portions 704 disposed thereon. Such electrical connection portions 704 can be of any conductive material, such as copper and copper alloys, as well as other metals, and can be formed as pads, lines, traces, or other configurations.

The surface of the first extension portion 422 can have additional surface connection portions 710 configured and positioned to couple with the electrical connection portions 704 of the display unit 500 when it is coupled to the first extension portion 422. The electrical connections formed by contact between the surface connection portions 710 and electrical connection portions 704 can permit power and information coupling between the display unit 500 and one or more processing devices disposed in or embodied in other components of the display assembly 400, such as the side portions 420, 430. Thus, the display device 452 can be operated by a processing device in the first or second side portions 420, 430, as coupled through the electrical connections. In certain embodiments, the electrical connection between the display unit 500 and the relevant extension portion 422, 432 can be formed using different physical features if desired. For example, a plug and socket configuration can be used, among other techniques. In embodiments comprising such contact electrical surfaces, the wire 480 can be omitted, including those portions of the display assembly 400 associated with the wire 480, including the first and second grooves, retaining flanges, wire port, and so on. Alternatively, such features can be included if desired.

The display unit 500 can be uncoupled from the rest of the display assembly 400 when detached from an extension portion, and interchangeable between different display assemblies.

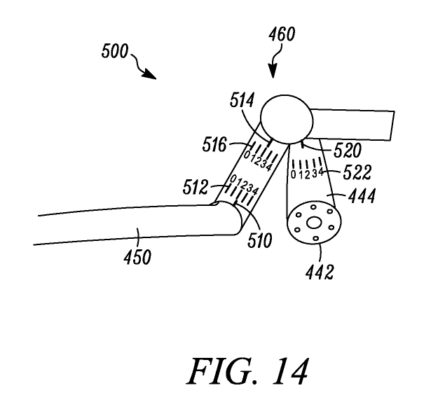

FIG. 14 illustrates a detailed view of the display unit 500 near the joint assembly 460. A user can arrange the audio arm 444 and display device 452 in a desired position repeatedly after adjusting the position of the display unit 500. To assist the user, certain components can have features which aid the user in repeatedly positioning them. For example, each portion of the joint assembly 460 can have a ratcheting mechanism which positions one or more arms of the joint assembly 460 in a plurality of discrete locations. The ratcheting mechanism can provide auditory and/or tactile feedback, such as a clicking noise or sensation when changing between discrete positions.

Additionally, as an example, the display extension member 450 can have an indicator 510 which rotates when the display extension member 450 rotates. The joint assembly 460 can have a numerical indicator field 512 against which the indicator 510 moves. The positions of numbers in the numerical indicator field 512 can correspond to discrete positions, allowing a user to remember a desirable setting. Other indicators 514, 520 can perform similar functions against other numerical indicator fields 516, 522. For example, the audio arm 444 can have a numerical indicator field 522 which is present adjacent an indicator 520 of the joint assembly 560. Accordingly, the audio arm 444 can be easily positioned in a repeated position desired by the user by adjusting to the same numerical indicator.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A head-mounted display apparatus comprising:
a rear coupling member having a right end, a left end, and a central portion;
a first lateral support member coupled to the right end of the rear coupling member and extending forward from the rear coupling member;
a second lateral support member coupled to the left end of the rear coupling member and extending forward from the rear coupling member; and
a selectively positionable display assembly adapted to releasably couple to and be supported by either the first lateral support member or the second lateral support member, interchangeably, such that the selectively positionable display assembly extends forward from the first lateral support member when coupled to the first lateral support member and forward from the second lateral support member when coupled to the second lateral support member.

2. The head-mounted display apparatus of claim 1, further comprising a wire adapted to couple the rear coupling member to the selectively positionable display assembly.

3. The head-mounted display apparatus of claim 2, wherein the first and second lateral support members each have at least one groove adapted to receive the wire.

4. The head-mounted display apparatus of claim 3, wherein at least one of the at least one groove on the first lateral support member is a different length than at least one of the at least one groove on the second lateral support member.

5. The head-mounted display apparatus of claim 3, wherein each of the at least one groove has a flange adapted to retain the wire within the groove.

6. The head-mounted display apparatus of claim 1, wherein the selectively positionable display assembly comprises a wireless antenna.

7. The head-mounted display apparatus of claim 1, wherein the selectively positionable display assembly comprises a flexible extension portion coupled to a display device, the display device adapted to produce visual images.

8. The head-mounted display apparatus of claim 7, wherein the display device is rotationally coupled to the flexible extension portion.

9. The head-mounted display apparatus of claim 7, wherein the flexible extension portion is adapted to be positioned in a plurality of discrete orientations relative to the lateral support member to which it is coupled.

10. The head-mounted display apparatus of claim 9, wherein the flexible extension portion is adapted to emit an audible sound when changed between discrete orientations.

11. A head-mounted display system comprising:
a first forward extension portion;
a second forward extension portion substantially parallel to the first forward extension portion; and
a swappable display device adapted to be selectively and releasably coupled to the first forward extension portion and to the second forward extension portion.

12. The head-mounted display system of claim 11, the swappable display device comprising a graphical display adapted to produce visual images in a plurality of orientations.

13. The head-mounted display system of claim 12, wherein the graphical display comprises a transparent screen.

14. The head-mounted display stem of claim 12, wherein the swappable display device comprises a flexible member, the graphical display is contained within a housing, and the housing is rotationally coupled to the flexible member.

15. The head-mounted display system of claim 11, the swappable display device comprising at least one audio sensor.

16. The head-mounted display system of claim 11, the swappable display device comprising an audio device.

17. The head-mounted display system of claim 16, wherein the audio device is rotationally coupled to the swappable display device and the audio device is adapted to rotate through at least one hundred eighty degrees.

18. A display device for a head-mounted display apparatus, the head-mounted display apparatus comprising left and right forward extension portions, and the display device adapted to selectively and releasably couple to either the left forward extension portion or to the right forward extension portion, the display device extending forward from the forward extension portion to which it is coupled.

19. The display device of claim 18, the display device comprising a graphical presentation device adapted to produce a visual image in a plurality of orientations.

20. The display device of claim 18, wherein the display device comprises an audio device adapted to extend from the display device, the audio device positionable in a plurality of discrete orientations relative to the display device.
